(19) United States
(12) Patent Application Publication
(10) Pub. No.: US 2002/0021001 A1
(43) Pub. Date: Feb. 21, 2002

(54) Biometric authentication card, system and method

(75) Inventors: William D. Stratford, Missoula, MT (US); D. Scott Groesbeck, Missoula, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Micro Dot Security Systems, Inc.

(21) Appl. No.: 09/828,265

(22) Filed: Apr. 6, 2001

Related U.S. Application Data
(60) Provisional application No. 60/195,618, filed on Apr. 7, 2000.

(51) Int. Cl. B42D 15/00

(52) U.S. Cl. 283/74

(57) ABSTRACT

The present invention relates to microtags, including microdots, and methods for reading the information contained on such microtags, and coordinating and comparing this information with other data, which may or may not be transmitted for a combined approval. The invention further relates to methods for verifying a person's identity using microtags. More specifically, the present invention relates to a novel type of microtag wherein the identifying indicia contained on the microtag includes biometric indicia such as a fingerprint either in whole or in parts, and may also include nonbiometric information, such as account numbers. This invention also provides a method for reading biometric and nonbiometric information contained on such a microtag, and a method for using the biometric information on the microtag to verify a person's identity and to validate transactions.

### CROSS-REFERENCE(S) TO RELATED APPLICATION(S)

This application claims the benefit of Provisional Application No. 60/195,618, filed Apr. 7, 2000, and entitled FINGERPRINT MICROTAG AND METHOD OF USE, the benefit of which is hereby claimed under 35 U.S.C. §119.

### FIELD OF THE INVENTION

The present invention relates to microtags, including microdots, and methods for reading the information contained on such microtags, and coordinating and comparing this information with other data, which may or may not be transmitted for a combined approval. The invention further relates to methods for verifying a person's identity using microtags. More specifically, the present invention relates to a novel type of microtag wherein the identifying indicia contained on the microtag includes biometric indicia such as a fingerprint either in whole or in parts, and may also include nonbiometric information, such as account numbers. This invention also provides a method for reading biometric and nonbiometric information contained on such a microtag, and a method for using the biometric information on the microtag to verify a person's identity and to validate transactions.

### BACKGROUND OF THE INVENTION

As used herein, the term “microtag” refers to a substrate or substrates having indicia thereon which allows a person to identify the source of an article when the microtag is associated with that article. Examples of indicia include but are not limited to letters, numbers, figures and colors. The indicia contained on microtags generally cannot be read without magnification.

The term microtag includes “microdots”. Microdots, as the name implies, are usually small discs, often less than about two millimeters in diameter, cut from a substrate, usually film, having a unique information or indicia such as a preselected color or a specific serial number to enable the subsequent finder of the microdot to retrieve information from the microdot and therefore the origin or owner of the article to which the microdot is attached. The terms microtag and microdot are used interchangeably in this application.

Several microtag technologies are known in the art. Perhaps one of the earliest references in this field is that of Dillon (U.S. Pat. No. 4,243,734) which discloses a microtag configured as a square having a side dimension in the nature of 0.007 inch.

The identification system disclosed in U.S. Pat. No. 4,763,928 to Krietemeier et al. uses a plurality of small labels, not microtags per se. Krietemeier discloses small tags which are cut from a strip of plastic but releasably held on a substrate to allow the person applying the tags to individually retrieve a tag from the plastic strip and mount it on the item.

U.S. Pat. No. 5,429,392 to Loving describes a microtag comprised of several layers in which the layers impart specific preselected characteristics to the microtags, such as buoyancy, enhanced visibility, camouflage, magnetic attraction and controlled biodegradation.

Microtags are generally used to identify the source or owner of an article to which the microtag is associated. In one application, the microtag is imprinted with a specific serial number and is accompanied by several hundred or even thousands of identical microtags. These microtags are then placed at numerous locations on various items so that one or more of these microtags will later be retrieved and thereby reveal the ownership of the item. The principal concept is that it is virtually impossible to remove all the microtags from an item. In addition, some microtag systems are designed to allow a portion of the microtags to be dislodged during transit to thereby leave a trial of microtags which would provide credible evidence as to the prior locations of the item, thus aiding in the apprehension of the miscreant and any cohorts.

In another application, selected surface materials are applied to the microtag to impart to the microtag a preselected characteristic. In one embodiment a holographic film having a broad-spectrum holographic effect is affixed to one set of microtags to thereby render the microtags readily visible at a significant distance. Another microtag is encapsulated in a waterproof film, the density of the film being preselected so as to impart predetermined buoyancy to the microtag. A magnetic material affixed to another microtag renders the microtag capable of being magnetized and even recoverable using a magnetic collector. Camouflage-like layers allow for the unobtrusive distribution of the microtags on or in an item without otherwise revealing the presence of the microtags. Certain applications will also benefit from a microtag that will suitably biodegrade over a preselected period of time. These variations in the characteristics of the microtags make them suitable for tagging and identifying various types of substances and articles, including but not limited to soil, sewage, industrial waste, etc.

From the foregoing it is clear that various attempts have been made to provide a microtag identification system. However, previous microtag systems involve a time lag between retrieval or location of the microtag, determination of the indicia contained on the microtag, and identification of the owner of the property to which the microtag is attached. What is needed in the art is a microtag identification system, which allows on the spot identification of the owner of the property to which the microtag is attached or associated with.

### SUMMARY OF THE INVENTION

The present invention provides a microtag identification system which allows on-the-spot identification of the owner of a card (identification, credit card, license, single microtag application or any other token or structure susceptible to use with a microtag) to which the microtag is attached or associated with. The present invention uses either a single layer or multi-layer microtag (as disclosed in U.S. Pat. No. 5,429,392 to Loving and incorporated herein by reference). One type of identifying biometric indicia is a fingerprint (with or without additional nonbiometric information) of the owner of the card to which the microtag is associated. However, those of ordinary skill in the art will appreciate that many types of biometric indicia may be used in conjunction with microtags, including, but not limited to: hand prints, facial image, retinal images or even analog representations of DNA. It will be appreciated by those of ordinary skill in the art that any type of identifying characteristics or images may be contained on the microtag. The microtag can then be embedded on a piece of plastic, or other surface, and can be used for on-the-spot confirmation that a person presenting a piece of personal identification is the owner (or authorized user) of that identification. It is expected that the microtags and methods of this invention will be particularly useful in securing credit cards, drivers licenses, personal identification cards, access cards, as well as the single microtag applications, etc.

In accordance with one embodiment of the present invention, a person's fingerprint is obtained and then reduced for application to a microtag using methods of image reduction known in the art. The fingerprint is put on the microtag, possibly along with encrypted information, if the encrypted information is needed. After construction of the microtag, the microtag is affixed to a card that has been associated with the fingerprint. The microtag may be embedded into the card, or attached to the surface of the card in some conventional manner.

The card containing the fingerprint can then by analyzed on site to confirm that the holder of the card is authorized to access the account (or other desired access site). Merchants would maintain a real time fingerprint analysis device on site, which is able to read both the card and the fingerprint of the cardholder. The reading device is expected to magnify the picture of the fingerprint on the microtag and compare it to the live person's fingerprint. If the fingerprints fail to match, then the reading device would store the fingerprint so the police would have an actual fingerprint of the person trying to make unauthorized use of the card. In addition, the card company could call the person who owns the card and verify it was stolen immediately while the transaction was being processed. On the other hand, if the fingerprint microtag on the card matches the live person's fingerprint then access would be granted. Then a representation of the fingerprint on the card, which is possibly from the magnetic strip, is sent in to card issuer (e.g.: VISA and MasterCard). In one embodiment, during a normal credit card transaction, a “hook” is added to the data sent back to the terminal. The hook ties the card to the microtag, to the live person and to the plastic credit card itself. In one embodiment, the fingerprint verification would be encrypted or added to the beginning of a validation chain to initiate or validate an e-chip process.

Therefore, a primary aspect of this invention provides for improvements in microtags.

Another aspect of this invention provides improvements in the methods of reading microtags.

Yet another aspect of this invention is to provide a method for real-time identification of the owner of a card where a microtag is associated.

These and other aspects and features of the present invention will become more readily apparent from the following description in which various embodiments of the invention have been set forth in conjunction with the accompanying drawing and appended claims.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A shows a card having a fingerprint microtag contained thereon;

FIG. 1B shows a microtag containing a biometric and nonbiometric information;

FIG. 2A shows a card having a fingerprint microtag contained thereon inserted in the scanner reader;

FIG. 2B is a top view of a scanner reader of the fingerprint microtag.

FIG. 3 is an illustrative verification system used to authenticate the microtag credit cards of the present invention.

FIG. 4 is a flow chart of the verification steps that occur on site when a card containing the microtag is presented for a transaction.

FIGS. 5-6 are flow charts of additional verification steps that occur when a card containing the microtag is presented for a transaction.

### DETAILED DESCRIPTION

The drawing figures are intended to illustrate the general manner of construction and are not to scale. In the description and in the claims, the terms left, right, front and back and the like are used for descriptive purposes. However, it is understood that the embodiment of the invention described herein is capable of operation in other orientations than are shown and the terms so used are only for the purpose of describing relative positions and are interchangeable under appropriate circumstances.

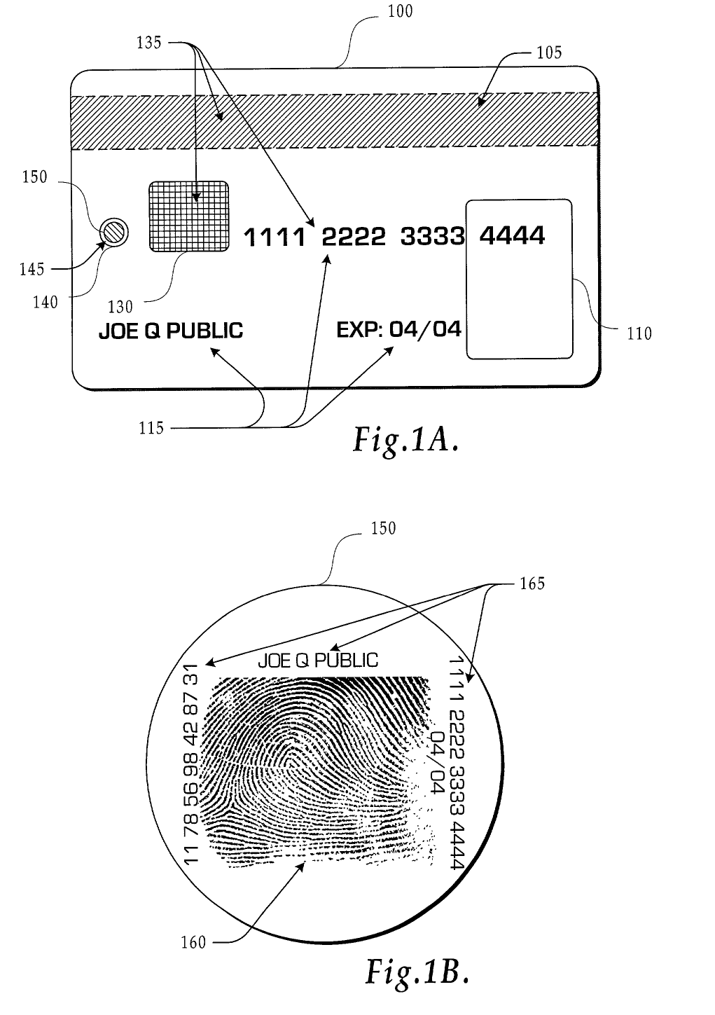

FIG. 1 illustrates a card 100 (or other suitable structure for holding a microtag), incorporating features in accordance with an exemplary embodiment of the present invention. Card 100 may be comprised of plastic, metal or any other material suitable for construction of an account access token known in the art. The card 100 may carry account information media 135 such as a magnetic strip 105, embossed symbols 115 or a smart chip 130. For purposes of discussion of the present invention the magnetic strip 105, embossed symbols 115 or smart chip 130 may be used interchangeably when referring to account information media 135. Furthermore, reference to the account information media 135 may also be used to identify any other suitable readable medium known to be adaptable to carry account identifying information in the present invention. Therefore, in one actual embodiment, the magnetic strip 105 carries account information on at least one account to which a user of card 100 may gain access. Such account information may comprise credit or debit account numbers, a digitally-formatted biometric, PIN authentication information or other information known in the art to be suitable for identifying accounts.

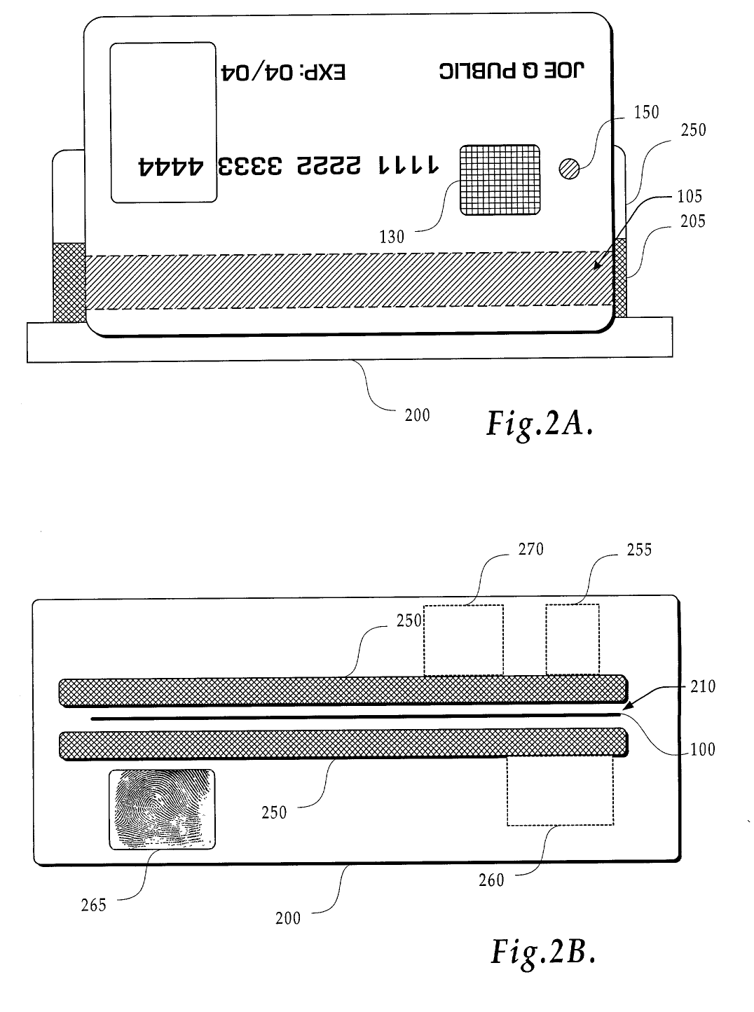

Card 100 further comprises a cutaway region 145 punched or otherwise formed from and at least partially through card 100. A transmissive (or possibly reflective or opaque) member 140 occupies cutaway region 145. For purposes of the present discussion, the term “transmissive” shall be synonymous with the term “nonopaque.” Transmissive member 140 is potentially cellulose-based, but may comprise any suitable transmissive film material known in the art. Alternatively, transmissive member 140 is carried by card 100 at a corner or edge of card 100. A biometric layer 150 is disposed on a surface or between surfaces of transmissive member 140. The biometric layer 150 is composed, at least partially, of a material that is opaque or of lower transmissivity than that of transmissive member 140 and defines a biometric. As illustrated in FIG. 2, the biometric 160 defined by layer 150 is, in one actual embodiment, a fingerprint, although the biometric 160 could comprise any biometric susceptible to analog formatting, including but not limited to facial images, hand prints, retinal images, handwriting samples or even analog representations of DNA. As such, an image of the biometric 160 defined by biometric layer 150 may be projected upon a surface by directing light through transmissive member 140, or by reflecting light back from transmissive member 140 through the biometric layer 150 if the transmissive member 140 is reflective.

In one exemplary embodiment of the present invention, card 100 is created by an issuing entity, such as a bank, credit card company, a license department or passport issuing authority, upon receipt of an application to establish an account or privilege to be accessed by a user. As part of this application process, the user will submit a biometric, possibly a fingerprint, to the issuing entity. The issuing entity, in turn, replicates the submitted biometric to form biometric layer 150 and digitizes the submitted biometric for storage and later comparison with a digitized image of biometric layer 150, as discussed in further detail below.

In accordance with the present invention, before receiving a card 100 a customer (user) completes an application (not shown), possibly a credit card application, drivers license application, personal identification card application or other form of application associated with an account or desired access. Such an application would have a designated region for recording a biometric of the user, such as a box on which the applicant must place their thumb or fingerprint. The user may also supply a picture, signature, blood, retinal image, hand print or other biometric information known in the art. The completed application is then sent to the card issuer, licensing department or other appropriate location, for processing.

In one embodiment, a image is taken with a high-resolution camera of the fingerprint (or other biometric) characteristics. The image may also include additional non-biometric information 165 (possibly encrypted) from the application, or produced by the card issuer. The image is then reduced in size and transferred to microfilm using well-known methods in the art. The microfilm is then either converted into or placed onto a substrate forming a microtag 150.

After the microtag 150 is embedded into the card 100, it is sealed with a laminate. In one embodiment the microtag 150 may be punched out of the film as a 7/32″ microdot and embedded into the card 100 in a single motion. In an actual embodiment, the card 100 comprises a flat (or angled) countersink of 5/16″ in diameter with a 1/8″ hole punched in the countersink. In an actual embodiment, the countersink rim is 5/1000″ and glue is placed in the countersink to affix the microtag 150 to the card 100. Then a clear coating or laminate (transmissive layer 140) covers the microtag 150 to protect it from the harsh environment the card 100 will operate in. (Note, transmissive laminates are already used on many credit cards and identification cards.) It will be appreciated that these are merely examples and the microtag might be of any shape or dimensions on the card 100.

Assuming the credit application discussed above is approved, the microtag 150 is then embedded onto a customer's card. The customer's card may also contain account information media 135 with information corresponding to non-biometric information 165 on the microtag.

Later the non-biometric information 165 may be used to confirm that the holder of a card is the actual owner of the card or an authorized user. By reading the non-biometric information 165 from a microtag 150 and comparing it to information from the account information media 135, it is possible to verify that the microtag 150 and account information media 135 both match. In one embodiment, the non-biometric information 165, the account information and the customer's information must all match before a transaction will be authorized.

In another exemplary embodiment, when information is transmitted to a card issuer (e.g., VISA or MasterCard) under normal transaction procedures (such as by phone), an additional series of six or more digits will be added to the transaction that would not come back to the point-of-sale machine. These digits would represent the biometric of the person using the card and would stay in the permanent records of the card issue. Another term for these digits is a “score.” This feature is not currently used in the credit card world but their data streams are capable of doing it. Those digits would be unique to the biometric of the cardholder. If the microtag 150 was a forgery, then the score would not match the cardholder's biometric. This feature would add an additional layer of security into transactions and would allow the card issuer to track fraudulent attempts to use the card, too.

FIG. 2A is a partial upper perspective cross-sectional view of the authorization terminal 200. As can be seen in FIG. 2A, terminal 200 further comprises a microtag scanner 250 comprising a light source 255 disposed at one end of terminal 200 and adapted to project light through a transmissive region (not shown) of slot 210 and a lens apparatus (not shown) to an image capturing apparatus 260. Apparatus 260 may comprise a digital camera or scanner but may comprise any suitable imaging device known in the art. Mirrors or prisms (not shown) may optionally be included for directing light from light source 255 to apparatus 260, thereby enabling variable sizing of terminal 200 and placement of the Light source 255 and apparatus 260. Light source 255 may comprise a LED but may comprise any suitable light-emitting device known in the art. Preferably, a switch (not shown) is disposed proximate to slot 210 in such manner as to activate light source 255 in response to insertion of card 100 into slot 210. Terminal 200 further is further coupled to (and possibly part of) a clearing device 300 that communicates with the apparatus 260, light source 255, magnetic reader 205, biometric scanner 265 and microtag scanner 250 via a bus (not shown) or other suitable connecting device. Alternatively, clearing device 300 may be disposed externally to but in communication with the components of terminal 200.

The clearing device 300 may be configured to perform a plurality of functions according to the teachings of the present invention. These functions are typically performed by software code modules stored in a memory (not shown) and executing on a CPU (not shown), both of which are conventional components at a clearing device. The functions may also be performed by hardware modules coupled to clearing device 300, or by a combination of software and hardware modules. Each step of the inventive processes discussed below not requiring manual activity may be performed by clearing device 300, terminal 200, and account agency server 350 in response to such code modules.

FIG. 2B is an upper perspective view of an authorization terminal 200 in accordance with the present invention. In one actual embodiment the terminal 200 is adaptable to be mounted on any supporting surface involved in a point of sale or financial transaction. Terminal 200 comprises a slot 210 adapted to receive card 100. Slot 210, in one exemplary embodiment, comprises a magnetic reader 205 and/or other devices, such as smart card reader 270, adapted to read information from an account information media 135. Terminal 200 further comprises a biometric sampler such as a biometric scanner 265 that communicates with other components of terminal 200. Scanner 265 may be a fingerprint scanner, retinal scanner, hand print scanner, digital camera or other biometric scanner as is known in the art. Terminal 200 optionally further comprises a printer, LED display or LCD display 310 and/or a keypad (not shown).

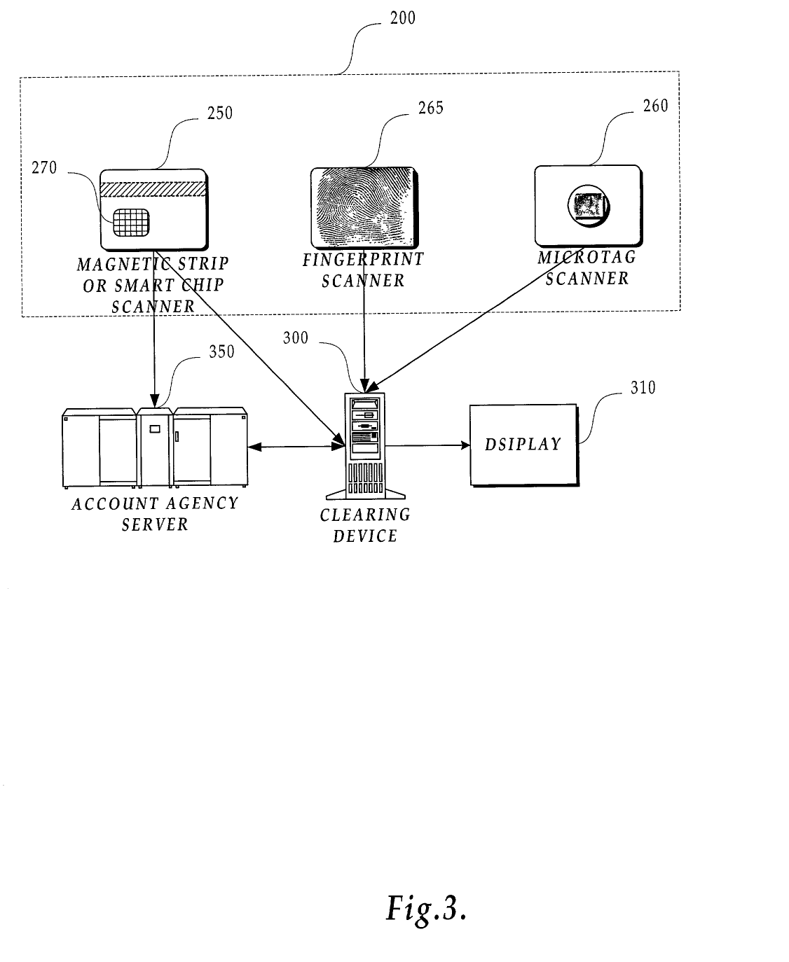

FIG. 3 illustrates a system in accordance with the present invention for authenticating a transaction using a card 100 having a biometric microtag 150. The system comprises a clearing device which actually issues the authorization. The clearing device, 300 is in communication with a microtag scanner 260, a biometric scanner 269, an account information reader such as magnetic strip reader 290, or smart card reader 270, all of which may be on the terminal 200. The clearing device is also in communication with an account agency server 350. The clearing device 300 may optionally be in communication with some form of output device such as a display 310, or a printer (not shown).

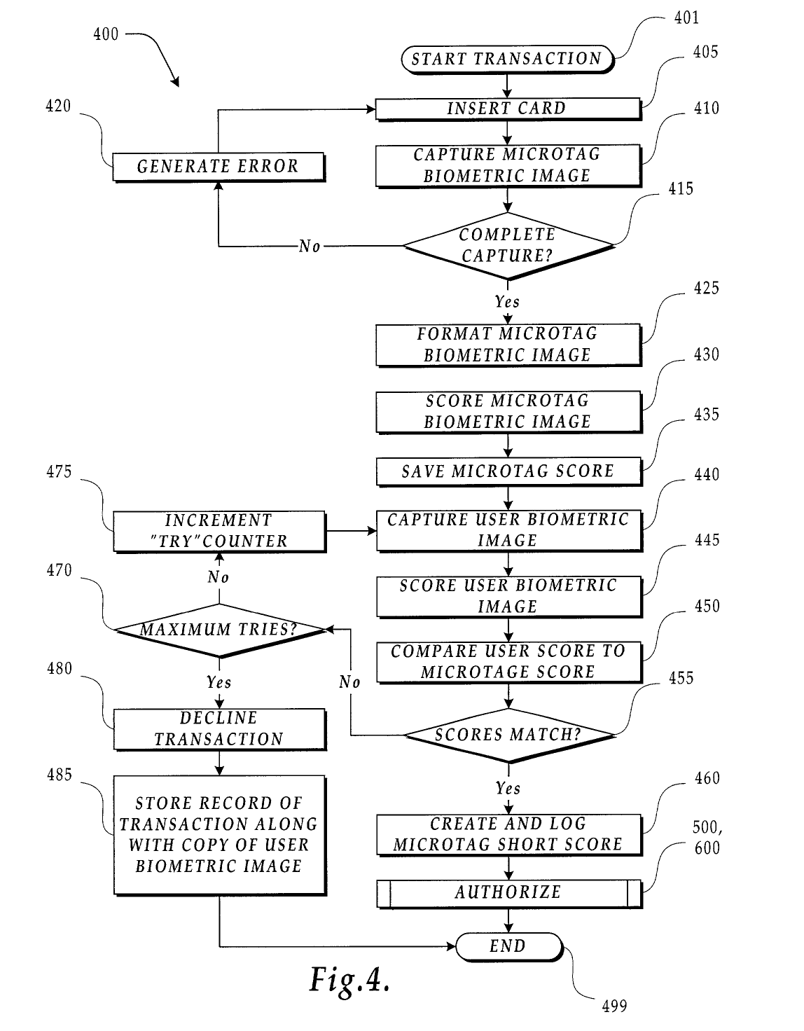

FIG. 4 is a flowchart depicting authentication and/or identification of a user attempting to access an account (or other desired access) using card 100. At initial step 405, card 100 is inserted into slot 210 of terminal 200. Insertion of card 100 into slot 210 triggers a switch that activates light source 255. Insertion of card 100 into slot 210 enables alignment of transmissive member 140 with light source 255. Light emitted by source 255 passes through transmissive member 140 and projects an image of biometric layer 150 through a lens to imaging apparatus 260. At step 410, apparatus 260 captures the projected image and transmits the projected image to the clearing device 300. If, for whatever reason, an incomplete or insufficient projected image is so transmitted as determined in decision block 415, then an error signal may be generated in block 420, and the process begins again. Otherwise, at block 425, the clearing device 300 formats the image of the microtag 150 by centering, deskewing, sizing, and cropping the image to a desired size (in one embodiment, 400 pixels by 400 pixels). During formatting, the projected image may then be formatted into a digital image, such as a bitmap, GIF, JPEG, TIFF or other appropriate digital image format. At step 430, the clearing device 300 “scores” the formatted image, to create an indicator in the form of a first full digital string describing the biometric image 160 on the microtag 150.

At step 435, the first full digital string is stored in temporary memory. At step 430, the cardholder supplies the same form of biometric stored in biometric layer 150 (i.e. a fingerprint from the finger from which a fingerprint was taken in the application process described above) to scanner 265. At step 440, the biometric cardholder is scanned to create a user biometric image and clearing device 300 formats this image to a similar size as described above in step 415. At step 445, the clearing device 300 then formats the user biometric image, thereby creating a second full digital string describing the entire user biometric image. At step 450, the clearing device 300 compares the first and second full digital strings.

If decision block 455 determines that a predetermined and variable percentage of the second full digital string matches the first full digital string, then, at step 460, the clearing device 300 isolates a predetermined portion of the first full digital string and stores this isolated indicator in the form of a first “short” digital string in temporary memory. By creating and manipulating short strings, the system of the present invention both speeds up processing by using less information, and actually undermines attempts to reproduce the biometric for fraudulent purposes. For further security, the first short string, and each of the short strings described herein, may be encrypted in a manner known in the art. In the one actual embodiment, the first short string, and each of the short strings described herein, is a variable predetermined number of contiguous digits within the full digital string (possibly as few as 6 digits). However, each short string may alternatively comprise digits selected from a variable predetermined set of positions, either contiguous or non-contiguous, within the full digital string. In yet a further alternative, the short strings may be generated using a conventional hashing routine to produce a short string from a full length string.

At step 465, the attempted transaction is allowed to proceed. If decision block 455 determines that there no such match is verified, then (assuming that a maximum number of tries has not been reached as determined in block 470) at step 475, a counter is incremented and the process conditionally returns to step 440. In one exemplary embodiment the process 400 returns to block 440 up to twenty times or until match verification occurs in decision block 455. Each scanned image of the user's biometric is saved in temporary memory during each repetition. If, after a predetermined number of maximum returns to block 440 (e.g., more than twenty), as determined by decision block 470 with no match verification as determined by decision block 455, then, at block 480, a decline signal is generated. Then, at step 485, the scanned images of the user's fingerprint saved in temporary memory are saved in a permanent memory location and may optionally be transmitted to law enforcement agencies if appropriate. In any case processing of process 400 ends at block 499.

In another embodiment of the present invention, as discussed above, an account agency server 350 (or other computing device under the control of the account agency) digitizes the biometric of the cardholder during the process of application for card 100. Digitization of this biometric yields a third full digital string describing the entire biometric submitted in the application process. The issuing entity isolates a predetermined portion of the third full digital string to create a third short digital string. The third short string is taken from a region of the third full string corresponding to the region of the first full string from which the first short string was taken. Like correspondence should be assumed throughout the discussion herein of short string creation. The third short digital string is stored in the account agency server 350, preferably at a site under the control of the issuing entity. As is the case with the above-discussed first full digital string, the third full digital string is may be quite large, in one embodiment is my include be many as 1248 digits, however in other embodiments it may have more or less digits. As is the case with the above-discussed first short digital string, the third short digital string may have as few as 6 digits.

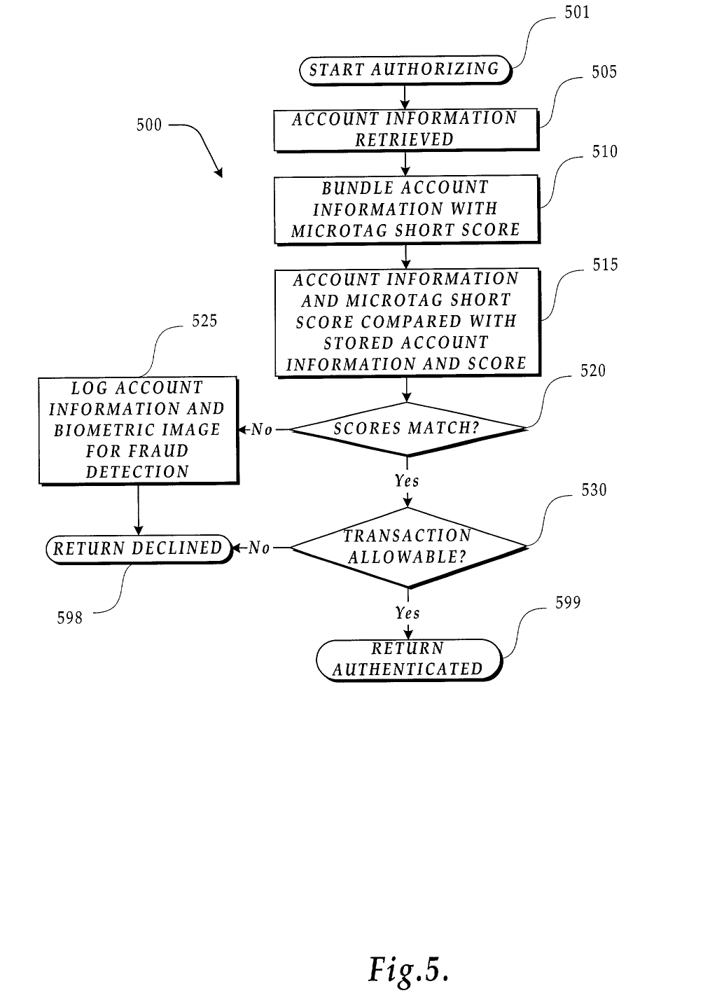

As shown in FIG. 5, the authorization sub-process 500 stars at block 501 and proceeds to step 505 whereupon information pertaining to the account associated with card 100 is read from information medium/media 135. Alternately, the user removes card 100 from slot 210 and inserts card 100 in an optional device (not shown) adapted to read information medium/media 135, in communication with terminal 200 and/or clearing device, and known in the art. The user may be prompted to remove card 100 from slot 210 (or the optional reader) by a generated message on a display 310, an audible signal generated by a speaker (not shown) incorporated into terminal 200, or other appropriate devices known in the art. At step 510, the first short digital string is bundled with the account information read at step 505, and this bundled data is transmitted to the above-discussed account agency server 350 associated with the issuing entity. At step 515, the account agency server 350 retrieves the third short digital string from a database controlled by the issuing entity and compares the first and third short strings.

If a predetermined and variable percentage of the first short digital string matches the third short digital string, sub-process 500 proceeds to step 499 and an authentication signal is returned. If no such match is verified in decision block 520, then, at step 525, the scanned image of the cardholder's biometric saved in temporary memory is saved in a permanent memory location and can be transmitted to law enforcement agencies if appropriate, and a record of the failed transaction is logged. Sub-process 500 then returns at block 598 with a declined signal. Alternatively, repeated subsequent derivations of a first short string from the token and comparisons of these first short strings with the third short string may be performed a predetermined number of times. Terminal 200 is then reset for the next transaction. In still another alternative, the second short digital string (corresponding to the user's biometric and not the microtag stored biometric), could be transmitted to the account agency server 350 and compared with the third short digital string in order to facilitate the above-described process.

At step 530, the account agency server 350 evaluates the bundled account information. If the account to which access is desired meets qualifying requirements (e.g., account is not overdrawn, credit limit not exceeded, user is authorized entry, etc.), the process proceeds to step 535. If the account requirements are not so met, then Sub-process 500 returns at block 598 with a declined signal. If the process is so terminated, then, the temporary memory containing the samples of the live biometric scan and the read account information is will be cleared or reset at the terminal 200 to make it ready for the next transaction.

Otherwise, if the transaction is allowable, then at step 599, a verified code or other information indicating acceptance of the transaction is returned (and optionally displayed on display 310). The temporary memory containing the samples of the live biometric scan and the read account information is will be cleared or reset at the terminal 200 to make it ready for the next transaction.

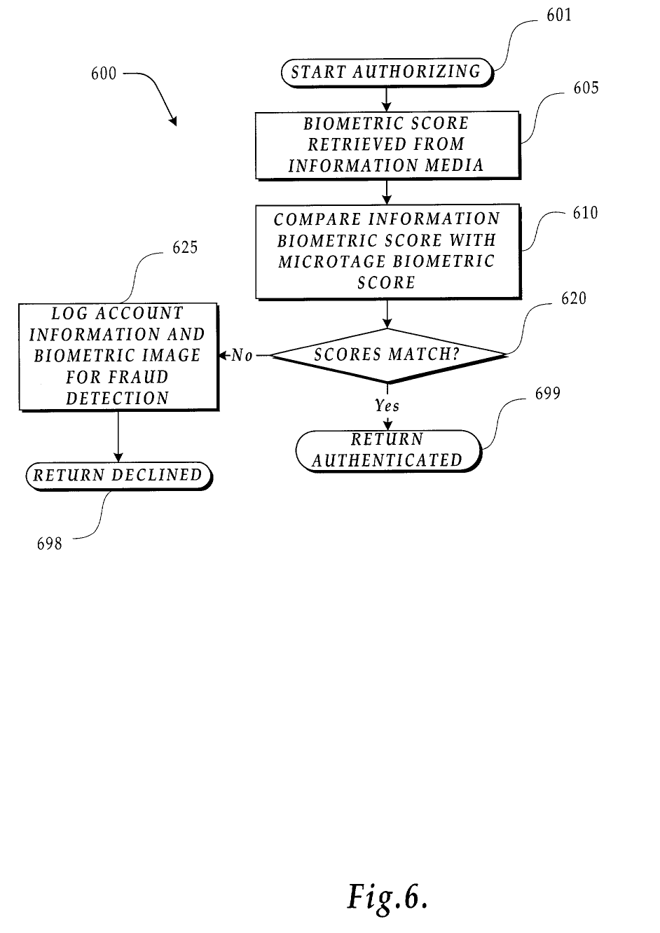

In an alternative embodiment of the present invention, the third short digital string is stored on information medium/media 135. Terminal 200 is equipped in conventional manner to read data from information medium/media 135. Accordingly, when card 100 is inserted into slot 210, terminal 200 reads the third short string from information medium/media 135. In this embodiment, and as shown in FIG. 6, the process 600 starts at block 601 and proceeds to step 605 whereupon information pertaining to the account associated with card 100 and the third short string are read from information medium/media 135. Alternatively, the user removes card 100 from slot 210 and inserts card 100 into an optional device adapted to read information medium/media 135, in communication with terminal 200, and known in the art. The user may be prompted to remove card 100 from slot 210 (or optional reading device) by a generated message on display 310, an audible signal generated by a speaker incorporated by terminal 200, or other appropriate device known in the art. At step 610, processor 200 compares the first and third short strings.

If decision block 630 determines that a predetermined and variable percentage of the first short digital string matches the third short digital string, the process proceeds to block 699, a verified code indicating authorization of the transaction is generated (and optionally displayed on display 310). The temporary memory containing the samples of the live fingerprint scan and the read account information may then be cleared or reset.

If no such match is verified in decision block 620, then, at step 625, the scanned image of the user's biometric saved in temporary memory is saved in a permnanent memory location and can be transmitted to law enforcement agencies if appropriate, and a record of the failed transaction is logged. Sub-process 600 then returns at block 698 with a declined signal. Terminal 200 is then reset for the next transaction. Alternatively, the second short digital string, rather than the first short string, could be likewise compared with the third short digital string in order to facilitate the above-described process.

In yet another alternative embodiment of the present invention, a custodian of terminal 200 is satisfied that card 100 has not been forged and the user is the person to whom card 100 has been legitimately issued. Consequently, information pertaining to the account associated with card 100 is read from information medium/media 135 and the transaction is completed with out further authentication. The temporary memory containing the samples of the live fingerprint scan and the read account information is cleared or reset. Terminal 200 is then reset for the next transaction.

Although the invention has been described in terms of illustrative embodiments, it will be appreciated by those skilled in the art that various changes and modifications may be made to the illustrative embodiments without departing from the spirit or scope of the invention. For example, terminal 200 may incorporate or be used in conjunction with a point-of-sale token reader known in the art. In addition, the above-described system may similarly authorize access to an account by comparing full digital strings rather than short digital strings throughout the entirety of the above-described processes. In addition, during user identification, as illustrated in FIG. 4, short, rather than full, digital strings may be derived from both the first and second full strings and employed for comparison. In addition card 100 may comprise a passport, driver license, or door/zone access card. It is intended that the scope of the invention not be limited in any way to the illustrative embodiment shown and described but that the invention be limited only by the claims appended hereto.

The embodiments of the invention in which an exclusive property or privilege is claimed are defined as follows:

1. In a token-based account access arrangement employing a reader adapted to read from a token information pertaining to the account, the token having disposed thereupon a projectable biometric, a system for identity-based authorization of a user to use the token for access to the account, the system comprising:
a token receiver;
a light source disposed on a first side of said receiver;
an image capturing apparatus positioned to receive light emitted by said light source;
a clearing device in communication with said image capturing apparatus; and
a biometric sampler in communication with said clearing device.

2. The system of claim 1, wherein said image capturing apparatus is disposed on a second side of said receiver opposite said first side.

3. The system of claim 1, wherein said receiver comprises a transmissive region, a portion of said transmissive region coinciding with the projectable biometric upon receipt of the token by said receiver.

4. The system of claim 1, wherein said light source is adapted to project an image of the biometric upon said image capturing apparatus.

5. The system of claim 1, wherein said clearing device is adapted to compare at least one depiction of the biometric disposed upon the token with at least one depiction of a biometric sample of the user captured by said sampler.

6. The system of claim 1, further comprising:
a server remote from said token receiver, said server in communication with said clearing device.

7. The system of claim 6, further comprising a database in communication with said server, said database adapted to store a registration biometric, said server adapted to compare at least one depiction of said registration biometric with at least one depiction of a biometric sample of the user captured by said sampler.

8. A system for identity-based authorization of a user to access an account, the system comprising:
a token having disposed thereupon a projectable biometric;
a token receiver adapted to receive said token;
a light source disposed on a first side of said receiver;
an image capturing apparatus positioned to receive light emitted by said light source;
a clearing device in communication with said image capturing apparatus; and
a biometric sampler in communication with said clearing device.

9. The system of claim 8, wherein said image capturing apparatus is disposed on a second side of said receiver opposite said first side.

10. The system of claim 8, wherein said receiver comprises a transmissive region, a portion of said transmissive region coinciding with said projectable biometric upon receipt of said token by said receiver.

11. The system of claim 8, wherein said light source is adapted to project an image of said biometric upon said image capturing apparatus.

12. The system of claim 8, wherein said clearing device is adapted to compare at least one depiction of said biometric disposed upon said token with at least one depiction of a biometric sample of the user captured by said sampler.

13. The system of claim 8, further comprising:
a server remote from said token receiver, said server in communication with said clearing device.

14. The system of claim 13, further comprising a database in communication with said second. processor, said database adapted to store a registration biometric, said server adapted to compare at least one depiction of said registration biometric with at least one depiction of a biometric sample of the user captured by said sampler.

15. A system enabling token-based access by a user of a token to an account, the system comprising:
a token receiver;
a light source disposed on a first side of said receiver,
an image capturing apparatus positioned to receive light emitted by said light source;
a clearing device in communication with said image capturing apparatus;
a biometric sampler in communication with said clearing device; and
a token reader.

16. The system of claim 15, wherein said image capturing apparatus is disposed on a second side of said receiver opposite said first side.

17. The system of claim 15, wherein said token reader is adapted to read from a token information pertaining to the account.

18. The system of claim 15, wherein said receiver comprises a transmissive region, the token has disposed thereupon a projectable biometric, a portion of said transmissive region coinciding with said projectable biometric upon receipt of the token by said receiver.

19. The system of claim 15, wherein said light source is adapted to project an image of a projectable biometric upon said image capturing apparatus.

20. The system of claim 15, wherein said clearing device is adapted to compare at least one depiction of a biometric disposed upon the token with at least one depiction of a biometric sample of the user captured by said sampler.

21. The system of claim 15, further comprising:
a server remote from said token receiver, said server in communication with said clearing device.

22. The system of claim 21, further comprising a database in communication with said server, said database adapted to store a registration biometric, said server adapted to compare at least one depiction of said registration biometric with at least one depiction of a biometric disposed upon the token.

23. A method for token-based access by a user of the token to at least one account, the method comprising:
creating at least one first indicator (digital string) describing at least one portion of an analog biometric associated with (formed on) the token;
creating at least one second indicator (digital string) describing at least one portion of a biometric of the user;
comparing said first and second indicators, said comparing of said first and second indicators yielding either a successful or failed first identification of the user; and
upon successful first identification of the user, authorizing access by the user to the at least one account.

24. The method of claim 23, wherein said authorizing further comprises:
creating at least one third indicator (digital string) describing at least one portion of a registration biometric of the user;
comparing said first and third indicators, said comparing of said first and third indicators yielding either a successful or failed second identification of the user; and
upon successful second identification of the user, authorizing access by the user to the at least one account.

25. The method of claim 24, wherein said at least one third indicator is readable from the token.

26. The method of claim 23, wherein said authorizing further comprises:
creating at least one third indicator (digital string) describing at least one portion of a registration biometric of the user;
comparing said first and third indicators, said comparing of said first and third indicators yielding either a successful or failed second identification of the user; and
upon successful second identification of the user, authorizing access by the user to the at least one account.

27. The method of claim 26, wherein said at least one third indicator is readable from the token.

28. The method of claim 23, wherein said creating at least one second indicator further comprises scanning at least one finger of the user, said scanning producing said biometric.

29. The method of claim 23, wherein said analog biometric comprises an image of at least one fingerprint of the user.

30. The method of claim 29, wherein said image is disposed on microfilm.

31. The method of claim 23, wherein said successful first identification of the user is yielded if a predetermined percentage of said at least one second indicator matches said at least one first indicator.

32. The method of claim 24, wherein said successful second identification of the user is yielded if a predetermined percentage of said at least one first indicator matches said at least one third indicator.

33. The method of claim 23, further comprising storing said at least one first indicator in first (temporary) memory.

34. The method of claim 33, further comprising:
upon said successful first identification of the user, clearing said at least one first indicator from said first memory.

35. The method of claim 23, further comprising storing said at least one biometric portion in first memory.

36. The method of claim 35, further comprising:
upon said successful first identification of the user, clearing said at least one biometric portion from said first memory.

37. The method of claim 35, further comprising:
upon said failed first identification of the user, storing said at least one biometric portion in a second (permanent) memory.

38. The method of claim 24, further comprising storing said at least one first indicator in first memory.

39. The method of claim 38, further comprising:
upon said successful second identification of the user, clearing said at least one first indicator from said first memory.

40. The method of claim 24, further comprising storing said at least one biometric portion in first memory.

41. The method of claim 40, further comprising:
upon said successful second identification of the user, clearing said at least one biometric portion from said first memory.

42. The method of claim 40, further comprising:
upon said failed second identification of the user, storing said at least one biometric portion in a second memory.

43. A system for identity-based authorization of a user to access an account, the system comprising:
means for carrying a projectable biometric;
means for receiving said biometric carrying means;
means for projecting an image of said projectable biometric, said means for projecting disposed on a first side of said receiving means;
means for capturing said projected image, said means for capturing positioned to receive light emitted by said projecting means;
a clearing device in communication with said capturing means; and
means for sampling a biometric of the user, said sampling means in communication with said clearing device.

44. The system of claim 43, wherein said capturing means is disposed on a second side of said receiving means opposite said first side.

45. The system of claim 43, wherein said receiving means comprises a transmissive region, a portion of said transmissive region coinciding with said projectable biometric upon receipt of said carrying means by said receiving means.

46. The system of claim 43, wherein said projection means is adapted to project an image of said biometric upon said capturing means.

47. The system of claim 43, wherein said clearing device is adapted to compare at least one depiction of said biometric carried by said carrying means with at least one depiction of a biometric sample of the user captured by said sampling means.

48. The system of claim 43, further comprising:
a server remote from said receiving means, said server in communication with said clearing device.

49. The system of claim 48, further comprising means for storing a registration biometric, said storage means in communication with said server, said server adapted to compare at least one depiction of said registration biometric with at least one depiction of a biometric sample of the user captured by said sampling means.

50. A method for token-based access by a user of the token to at least one account, the method comprising:
creating at least one first indicator for describing at least one portion of an analog biometric associated with the token;
creating at least one second indicator for describing at least one portion of a biometric of the user;
comparing said first and second indicators for yielding either a successful or failed first identification of the user; and
upon successful first identification of the user, authorizing access by the user to the at least one account.

51. The method of claim 50, wherein said authorizing further comprises:
creating at least one third indicator for describing at least one portion of a registration biometric of the user;
comparing said first and third indicators for yielding either a successful or failed second identification of the user; and
upon successful second identification of the user, authorizing access by the user to the at least one account.

52. The method of claim 51, wherein said at least one third indicator is readable from the token.

53. The method of claim 51, wherein said at least one third indicator is readable from memory at a location remote from the site where said creating at least one first indicator step is performed.

54. The method of claim 50, further comprising storing said at least one first indicator in first memory.

55. The method of claim 54, further comprising:
upon said successful first identification of the user, clearing said at least one first indicator from said fast memory.

56. The method of claim 50, further comprising storing said at least one biometric portion in first memory.

57. The method of claim 56, further comprising:
upon said successful first identification of the user, clearing said at least one biometric portion from said first memory.

58. The method of claim 56, further comprising:
upon said failed first identification of the user, storing said at least one biometric portion in a second memory.

59. The method of claim 51, further comprising storing said at least one first indicator in first memory.

60. The method of claim 59, further comprising:
upon said successful second identification of the user, clearing said at least one first indicator from said first memory.

61. The method of claim 51, further comprising storing said at least one biometric portion in first memory.

62. The method of claim 61, further comprising:
upon said successful second identification of the user, clearing said at least one biometric portion from said first memory.

63. The method of claim 61, further comprising:
upon said failed second identification of the user, storing said at least one biometric portion in a second memory.

64. An access card, comprising at least one microtag; and at least one account information medium.

65. The access card of claim 64, wherein said at least one microtag contains biometric indicia.

66. The access card of claim 64, wherein said at least one microtag contains non-biometric indicia.

67. The access card of claim 66, wherein said non-biometric indicia are encrypted.

68. The access card of claim 64, wherein said at least one microtag contains biometric and non-biometric indicia.

69. The access card of claim 64, wherein said at least one microtag is transmissive.

70. The access card of claim 64, wherein said at least one microtag is reflective.

71. The access card of claim 64, wherein said at least one microtag is disposed on a transmissive layer.

72. The access card of claim 64, wherein said at least one microtag is disposed on a reflective layer.

73. The access card of claim 64, wherein said at least one account information medium is a magnetic strip.

74. The access card of claim 64, wherein said at least one account information medium is embossed indicia.

75. The access card of claim 64, wherein said at least one account information medium is a smart chip.
